(19) United States
(12) Patent Application Publication
(10) Pub. No.: US 2021/0241299 A1
(43) Pub. Date: Aug. 5, 2021

(54) METHODS AND APPARATUS FOR DETECTING AND CORRECTING ITEM PRICING ANOMALIES

(71) Applicant: Walmart Apollo, LLC, Bentonville, AR (US)

(72) Inventors: Narayana RAMINI, Pleasanton, CA (US); Meher Charan PINDIPROLU, Sunnyvale, CA (US)

(21) Appl. No.: 16/777,507

(22) Filed: Jan. 30, 2020

(51) Int. Cl. G06Q 30/02; G06Q 30/06; G06Q 10/08; G06N 20/00

(52) U.S. Cl. CPC G06Q 30/0206; G06N 20/00; G06Q 10/0838; G06Q 30/0641

(57) ABSTRACT

This application relates to apparatus and methods for identifying anomalies in item sales. The anomalies may be caused by, for example, wrongly priced items. In some examples, a computing device receives transaction data identifying the purchase of one or more items from a store or website, for example. The computing device applies a rule-based model to the transaction data to generate, for each item, a first value. The first value may be based on a number of rules violated. The computing device may also apply, for each item, a machine learning based model to the transaction data and to the first value to generate a second value. The second value may indicate a probability of an anomaly. The computing device may determine that an anomaly exists for an item based on the first value and the second value for the item, and may transmit an indication of the anomaly.

### TECHNICAL FIELD

The disclosure relates generally to retail systems and, more specifically, to systems and methods for retail data anomaly detection and correction.

### BACKGROUND

Retailers often change the selling price of an item. For example, online retailers may update prices of items sold on their websites. The prices of the items may be based on external factors, such as competitor prices, and internal factors, such as costs. If any external factor or internal factor changes, the price of the item may need to be adjusted. Similarly, the cost of items can change as well. For example, supply costs, labor costs, or delivery costs associated with items may increase or decrease. At least some of the time errors, such as data entry errors or item price labelling errors, may lead to the listing of a wrong price for an item. As a result, a retailer's sales may be affected. For example, if the price of an item is priced lower than intended, the retailer may lose money (or, at the very least, not make as much money) on each sale of the item. If an item is priced higher than intended, the retailer may not sell as many items as if the item were correctly priced. Similarly, if the cost of an item is incorrect, the retailer may price the item incorrectly, thereby, at least in some cases, decreasing profits on the item. As such, a retailer may benefit from identifying and correcting item price and cost errors.

### SUMMARY

The embodiments described herein are directed to automatically identifying anomalies, such as item price and cost anomalies. The embodiments may allow a retailer to identify anomalies based on the number of items sold over a period of time. For example, the embodiments may employ rule-based and machine learning based processes to identify unexpected high, or low, number of sales of a particular item (e.g., sales volume of the item). Based on the unexpected number of sales, the embodiments may identify a pricing or cost anomaly. The embodiments may allow the retailer to stop further sales of the item, correct the anomaly, and then allow for the continued sales of the item once the anomaly is corrected. As a result, the embodiments may allow a retailer to correct item pricing and cost anomalies, thereby increasing the profitability of those items when sold. Other advantages are recognized by those of ordinary skill in the art having the benefit of these disclosures.

In accordance with various embodiments, exemplary systems may be implemented in any suitable hardware or hardware and software, such as in any suitable computing device. For example, in some embodiments, a computing device is configured to receive transaction data identifying an item and a price of an item, and determine a first value based on applying a rule-based model to the item and the price of the item. The computing device may also be configured to determine a second value based on applying a machine learning model to the item, the price of the item, and the first value. The computing device may further be configured to determine a third value based on the first value and the second value. The computing device may also be configured to determine, based on the third value, whether the price of the item is an anomaly. The computing device may be configured to transmit an indication that the price of the item is an anomaly.

In some embodiments, a method is provided that includes receiving transaction data identifying an item and a price of an item, and determining a first value based on applying a rule-based model to the item and the price of the item. The method may also include determining a second value based on applying a machine learning model to the item, the price of the item, and the first value. The method may further include determining a third value based on the first value and the second value. The method may also include determining, based on the third value, whether the price of the item is an anomaly. The method may include transmitting an indication that the price of the item is an anomaly.

In yet other embodiments, a non-transitory computer readable medium has instructions stored thereon, where the instructions, when executed by at least one processor, cause a computing device to perform operations that include receiving transaction data identifying an item and a price of an item, and determining a first value based on applying a rule-based model to the item and the price of the item. The operations may also include determining a second value based on applying a machine learning model to the item, the price of the item, and the first value. The operations may further include determining a third value based on the first value and the second value. The operations may also include determining, based on the third value, whether the price of the item is an anomaly. The operations may include transmitting an indication that the price of the item is an anomaly.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an anomaly detection system in accordance with some embodiments;

FIG. 2 is a block diagram of the anomaly detection computing device of the anomaly detection system of FIG. 1 in accordance with some embodiments;

FIG. 3 is a block diagram illustrating examples of various portions of the anomaly detection system of FIG. 1 in accordance with some embodiments;

FIGS. 4A and 4B are block diagrams illustrating examples of various portions of the anomaly detection computing device of FIG. 1 in accordance with some embodiments;

FIG. 5 is a flowchart of an example method that can be carried out by the anomaly detection system 100 of FIG. 1 in accordance with some embodiments;

FIG. 6 is a flowchart of another example method that can be carried out by the anomaly detection system 100 of FIG. 1 in accordance with some embodiments; and

FIGS. 7A and 7B illustrate charts illustrating item volume surges in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

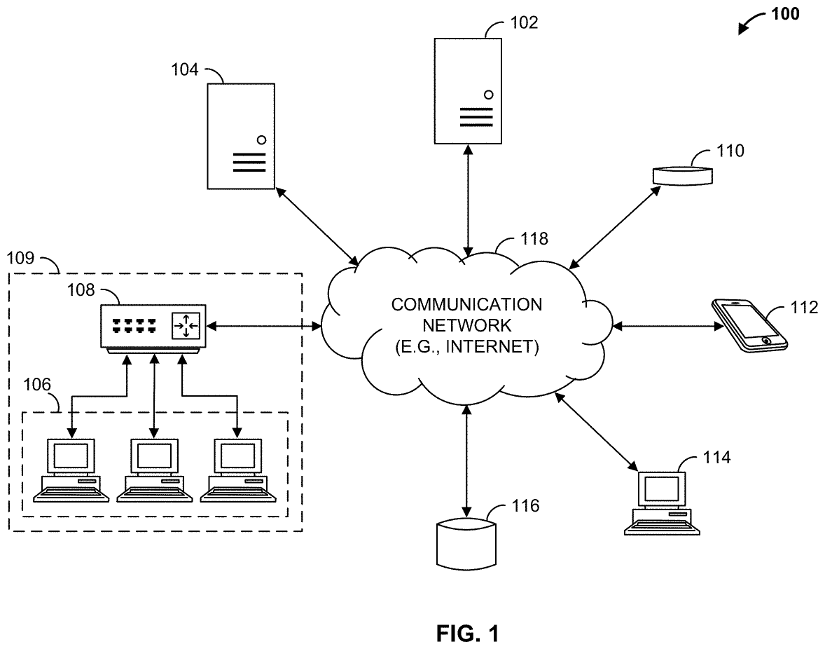

Turning to the drawings, FIG. 1 illustrates a block diagram of an anomaly detection system 100 that includes an anomaly detection computing device 102 (e.g., a server, such as an application server), a web server 104, workstation(s) 106, database 116, and multiple customer computing devices 110, 112, 114 operatively coupled over network 118. Anomaly detection computing device 102, workstation(s) 106, server 104, and multiple customer computing devices 110, 112, 114 can each be any suitable computing device that includes any hardware or hardware and software combination for processing and handling information. In addition, each can transmit data to, and receive data from, communication network 118.

For example, anomaly detection computing device 102 can be a computer, a workstation, a laptop, a server such as a cloud-based server, or any other suitable device. Each of multiple customer computing devices 110, 112, 114 can be a mobile device such as a cellular phone, a laptop, a computer, a table, a personal assistant device, a voice assistant device, a digital assistant, or any other suitable device.

Additionally, each of anomaly detection computing device 102, web server 104, workstations 106, and multiple customer computing devices 110, 112, 114 can include one or more processors, one or more field-programmable gate arrays (FPGAs), one or more application-specific integrated circuits (ASICs), one or more state machines, digital circuitry, or any other suitable circuitry.

Although FIG. 1 illustrates three customer computing devices 110, 112, 114, anomaly detection system 100 can include any number of customer computing devices 110, 112, 114. Similarly, anomaly detection system 100 can include any number of workstation(s) 106, anomaly detection computing devices 102, servers 104, and databases 116.

Workstation(s) 106 are operably coupled to communication network 118 via router (or switch) 108. Workstation(s) 106 and/or router 108 may be located at a store 109, for example. Workstation(s) 106 can communicate with anomaly detection computing device 102 over communication network 118. The workstation(s) 106 may send data to, and receive data from, anomaly detection computing device 102. For example, the workstation(s) 106 may transmit data related to a purchase order, such as the purchase of one or more items, to anomaly detection computing device 102. In some examples, anomaly detection computing device 102 may transmit an indication of whether there is an anomaly with the sales price of the item.

Anomaly detection computing device 102 is also operable to communicate with database 116 over communication network 118. For example, anomaly detection computing device 102 can store data to, and read data from, database 116. Database 116 can be a remote storage device, such as a cloud-based server, a memory device on another application server, a networked computer, or any other suitable remote storage. Although shown remote to anomaly detection computing device 102, in some examples, database 116 can be a local storage device, such as a hard drive, a non-volatile memory, or a USB stick. Database 116 may store, for example, transaction data identifying sales of items at store 109. Database 116 may also store transaction data identifying sales of items conducted online, such as on a webpage hosted by web server 104.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, web server 104 may host one or more webpages of a website. Each of multiple computing devices 110, 112, 114 may be operable to view, access, and interact with the webpages hosted by web server 104. In some examples, web server 104 hosts a webpage for a retailer that allows for the purchase of items. For example, the web page may list prices for advertised items. An operator of one of multiple computing devices 110, 112, 114 may access the webpage hosted by web server 104, add one or more items to an online shopping cart of the webpage, and perform an online checkout of the shopping cart to purchase the items. Web server 104 may transmit data related to the purchase of the items to anomaly detection computing device 102. In some examples, anomaly detection computing device 102 may transmit an indication of whether there is an anomaly with the sales price of any of the items.

Anomaly detection computing device 102 may detect whether a price of an item, such as an item sold at store 109 or on a website hosted by web server 104, is an anomaly. If anomaly detection computing device 102 detects that a price of an item is an anomaly, anomaly detection computing device 102 may report the anomaly. For example, if anomaly detection computing device 102 detects that a price of an item at a store (e.g., store 109) is an anomaly, anomaly detection computing device 102 may transmit a message to the store (e.g., via workstation 106) indicating that the price of the item has been detected to be an anomaly. In some examples, an associate of the store receives the message, and investigates whether the item is priced correctly. In some examples, the store may stop selling the item until the investigation is complete and, if needed, the price of the item is adjusted.

As another example, anomaly detection computing device may detect that the price of an item sold on a website, such as a website hosted by web server 104, is an anomaly. Based on the detection of the anomaly, anomaly detection computing device 102 may transmit a message to web server 104 indicating that the price of the item has been detected to be an anomaly. In response, web server 104 may generate an indication advising of the anomaly. For example, web server 104 may present the anomaly on a display to be viewed by one or more associates of a retailer that operates the website. In some examples, web server 104 generates a communication, such as an email or short message service (SMS) (e.g., text) to the one or more associates of the retailer. The associates may then further investigate the anomaly to determine if the item is priced correctly on the website.

In some examples, web server 104 prevents further sales of the item on the website. For example, web server 104 may prevent access to an item page (e.g., a webpage facilitating the purchase of an item) for the item. In some examples, web server 104 may disable an “add-to-cart” icon on the item page for the item. The web server 104 may allow for continuing sales of the item after receiving input from an associate of the retailer. For example, once the item price is investigated and, if required, adjusted on the website, the associate may “clear” the anomaly from the web server 104. In response, web server 104 may allow for the item to be sold on the website (e.g., by re-allowing access to the item page, or by reactivating the “add-to-cart” icon).

To detect anomalies, anomaly detection computing device 102 may employ one or more rule-based models (e.g., algorithms) and/or one or more machine learning based models. Anomaly detection computing device 102 may receive store transaction data identifying purchases at one or more stores, such as at store 109, and determine, based on execution of the one or more rule-based models and/or machine learning models, whether an item may be priced incorrectly (e.g., an item price anomaly). Similarly, anomaly detection computing device 102 may receive online transaction data identifying purchases at a website, such as a website hosted by web server 104, and determine, based on execution of the one or more rule-based models and/or machine learning models, whether an item sold on the website may be priced incorrectly.

In some examples, a rule-based model may employ one or more rules, such as predetermined rules, that operate on the received transaction data (e.g., store transaction data or online transaction data) to detect anomalies. The rules may, in some examples, be implemented as algorithms. The rules may be based on item prices, such as item unit prices and store item prices, item delivery amounts, item sales amounts, and/or item cost amounts, for example. Each rule-based model may employ one or more rules. Based on the outcome of each rule (e.g., whether the rule is violated or not), the rule-based model may generate a value (e.g., score). For example, if no rules are violated, the value may be 0. If one rule is violated, the value may be 1. If two rules are violated, the value may be 2, and so forth. In some examples, the rule-based model applies a weight based on the result of each rule. For example, a first rule may be weighted 20%, a second rule may be weighted 60%, and each of a third rule and fourth rule may be weighted 10%. For example, assuming the first rule and fourth rule are not violated, but the second rule and third rule are violated, the rule-based model may generate a value of 70 (based on a 100 point scale).

As an example of a rule, one rule may specify that if the price of an item is outside of a price range, the price of the item is an anomaly. For example, assume that meat is sold as store 109 (or on a website). Also assume a rule specifies that the price of meat is an anomaly if the price is outside a range of $1 per pound to $10 per pound. If, based on transaction data (in a transaction identified by the transaction data), the meat sold at a unit price of $5 per pound, the price is not an anomaly. If, however, the meat sold at, for example, $12 per pound, the rule detects the price of the meat as an anomaly.

In some examples, the rules may detect sales volume surges or declines. As an example, a rule may specify that if an item is sold more than a first threshold amount, or less than a second threshold amount, over a period of time (e.g., last month, last week, last quarter, etc.), there is a volume anomaly. For example, if the item sells at a store, such as store 109, (or website) more than the first threshold amount over the period of time, the item may be priced unexpectedly low. Similarly, if the item sells at the store (or website) less than the second threshold amount over the period of time, the item may be priced unexpectedly high.

As yet another example, another rule may identify item price anomalies if the price of an item is above, or below, a range of values determined based on historical prices. For example, the rule may specify that the price of an item is an anomaly if the price is above, or below, a percentage of the average price for the item over a period of time (e.g., the last 3 weeks, the last month, the same month last year, etc.). As such, the rule may have a “rolling window” that tracks item prices over the previous periods of time. In some examples, the rule may specify that an item price is an anomaly if the price is above or below a range of values based on a standard deviation of historical prices over the previous period of time. In some examples, a rule may be based on relevance values, median absolute deviation (MAD) values, correlation metrics, boxplot data, interquartile range (IQR) based data, or any other suitable data.

In some examples, the rules operate on a store price (e.g., the price of the item as advertised at a store, such as store 109) or online price (e.g., the price of the item as advertised on a website, such as a website hosted by web server 104). For example, database 116 may store current item prices for items sold at the store and/or the website. Anomaly detection computing device 102 may obtain the current item prices, and execute the one or more rules based on the current item prices.

In some examples, the rules operate on delivery amounts for an item. For example, database 116 may store delivery data indicating how much of each item has been delivered to a store (e.g., over a previous period of time), such as store 109, for sale. Similarly, database 116 may store delivery data indicating how much of each item has been delivered (e.g., to a warehouse) for sale on the website. Anomaly detection computing device 102 may obtain the item delivery amounts, and execute the one or more rules based on the item delivery amounts. For example, a rule may specify that if the delivery amount of an item to a store 109 over a previous period of time (e.g., a month) is above or below a range, a delivery anomaly exists, and the price that the item is selling at may be in error. As another example, a rule may specify that if a delivery amount of an item to a store 109 over a previous period of time (e.g., month) is above or below a standard deviation of historical delivery amounts (e.g., over the last year), the delivery amount is an anomaly.

In some examples, the rules are store or website specific. For example, one or more rules may operate on data (e.g., price data, delivery data) for a specific store, such as store 109. In some examples, one or more rules may operate on aggregated data for stores in a particular region (e.g., zip code, county, state, etc.), or on aggregated data for all stores in all regions. For example, a rule may determine that an item price is an anomaly if an item price that is based on the price of the item as sold (or as currently on sale) at a plurality of stores (e.g., an average price) violates the rule.

In some examples, in addition to or instead of the one or more rule-based models, anomaly detection computing device 102 may employ one or more machine learning models (e.g., algorithms) to detect anomalies. The machine learning model may be based on isolation forests, clustering, bayesian techniques, or boosted trees, for example. The machine learning models may be trained with historical transaction data, which can identify transactions made at stores, such as at store 109, and websites, such as at a website hosted by web server 109. The machine learning models may be trained using supervised, or unsupervised, learning. For example, anomaly detection computing device 102 may generate training data. The training data may identify, for each of a plurality of items, one or more of the following: the item (e.g., by item number, SKU number, etc.), prices for the item (e.g., prices the item sold at), an identification of where the item was sold at, and an indication of when the item was sold (e.g., a date and/or time). In some examples, the training data may identify item deliver amounts, historical item store prices, historical item unit prices, historical item delivery amounts, and historical item sales amounts for each of the plurality of items. In some examples, the machine learning model is trained with the output (e.g., output value) from the rule-based model.

In some examples, the machine learning model is re-trained with historical data over a previous period of time. For example, the machine learning model may be re-trained periodically (e.g., every week, month, three months, year, etc.) with transaction data corresponding to that period of time.

Once trained, the machine learning model may generate an output value indicating whether an anomaly is suspected. For example, anomaly detection computing device 102 may provide the machine learning model with an item, and a price of an item, and the trained machine learning model may generate an output value. In some examples, an anomaly is detected when the output value is beyond (e.g., above) a threshold amount. For example, assuming a scale of 0 to 100, an output value above 80 may indicate an anomaly. The threshold amount may be preconfigured.

In some examples, when the machine learning model identifies an anomaly (regardless of whether anomaly detection computing device 102 ultimately determined an anomaly exists, as described further below), the indication is stored in a database, such as database 116. An associate of a retailer may then determine whether the price of the item is incorrect. Based on the associate's findings, the associate may provide a verification indication (via, e.g., workstation 106 or web server 104) of whether the price for the item was or was not correct. The verification indication may also be stored in a database, such as database 116. Further, anomaly detection computing device 102 may generate training data based on the verification indication, and re-train the machine learning model with the training data. For example, based on the verification indication stored in the database, anomaly detection computing device 102 may generate supervised training data indicating that the price for the item was or was not an anomaly. Anomaly detection computing device 102 may then retrain the machine learning model with the supervised training data. As such, this feedback may improve output scores generated by the machine learning model.

In some examples, anomaly detection computing device 102 determines whether an anomaly exists based on the output (e.g., output values) of one or more rule-based models, and one or more machine learning models. For example, for a given item, anomaly detection computing device 102 may combine the output value generated by the rule-based model with the output value generated by the machine learning model to determine whether an anomaly is present. In some examples, anomaly detection computing device 102 adds the output values of each of a rule-based model and a machine learning model, and determines an anomaly is present if the combined value is beyond (e.g., above) a predetermined threshold. In some examples, anomaly detection computing device 102 applies a weight (e.g., different weight) to each of the output values of the rule-based model and the machine learning model, adds the weighted output values, and determines an anomaly is present if the resultant value is beyond a predetermined threshold. In some examples, anomaly detection computing device 102 applies one or more statistical processes (e.g., algorithms) to the output values of the rule-based model and the machine learning model to determine whether an anomaly is present.

In some examples, anomaly detection computing device 102 determines anomalies in real-time. For example, anomaly detection computing device 102 may receive store transaction data or online transaction data for a purchase made at a store or online, respectively. The transaction data may identify one or more items purchased, and one or more prices for the items purchased. Anomaly detection computing device 102 may execute one or more of the rule-based models and/or machine learning based models to determine if the price for an item purchased is an anomaly.

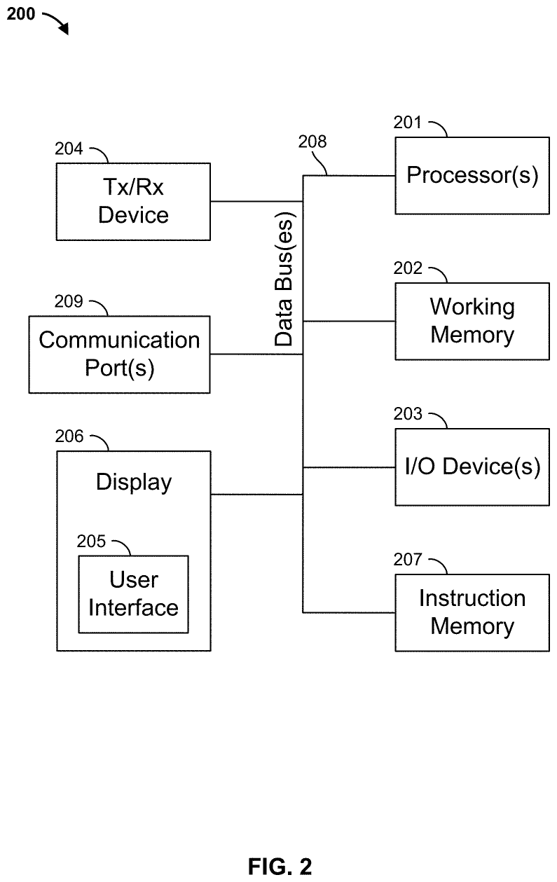

FIG. 2 illustrates the anomaly detection computing device 102 of FIG. 1. Anomaly detection computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of anomaly detection computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as machine learning algorithm training data.

Display 206 can display user interface 205. User interfaces 205 can enable user interaction with anomaly detection computing device 102. For example, user interface 205 can be a user interface for an application of a retailer that allows an associate to view determined item price anomalies. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 anomaly detection computing device 102 will be operating in. Processor(s) 201 is operable to receive data from, or send data to, a network, such as communication network 118 of FIG. 1, via transceiver 204.

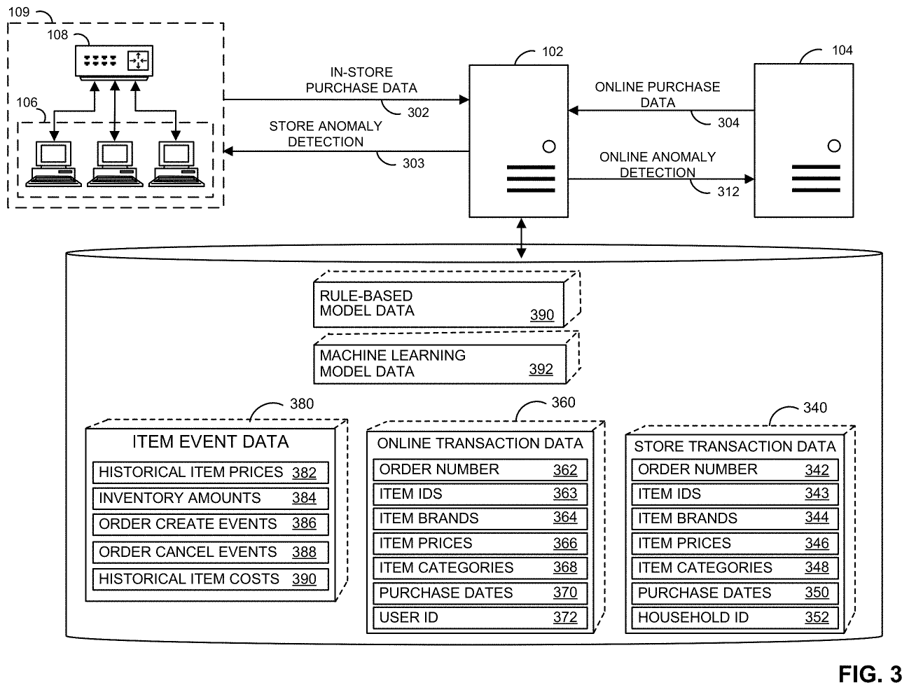

FIG. 3 is a block diagram illustrating examples of various portions of the anomaly detection system 100 of FIG. 1. As indicated in the figure, anomaly detection computing device 102 may receive in-store purchase data 302 identifying and characterizing one or more purchases from one or more stores 109. Anomaly detection computing device 102 may parse in-store purchase data 302 to generate store transaction data 340, and may store user transaction data 340 in database 116. In this example, store transaction data 340 may include, for each purchase order, one or more of: an order number 342 identifying a purchase order, item IDs 343 identifying one or more items purchased in the purchase order, item brands 344 identifying a brand for each item purchased, item prices 346 identifying the price of each item purchased, item category 348 identifying a category of each item purchased, a purchase date 350 identifying the purchase date of the purchase order, and a household ID 352 associated with the customer that purchased the order. Household ID 352 may be, for example, an address, a phone number, a surname, or any other information associated with the customer.

Similarly, anomaly detection computing device 102 may receive online purchase data 304 from web server 104, which identifies and characterizes one or more online purchases, such as from a retailer's website. Anomaly detection computing device 102 may parse online purchase data 304 to generate online transaction data 360, and may store online transaction data 360 in database 116. In this example, online transaction data 360 may include, for each purchase order, one or more of: an order number 362 identifying a purchase order, item IDs 363 identifying one or more items purchased in the purchase order, item brands 364 identifying a brand for each item purchased, item prices 366 identifying the price of each item purchased, item category 368 identifying a category of each item purchased, a purchase date 370 identifying the purchase date of the purchase order, and a user ID 352 associated with the customer that purchased the order. User ID 352 may be, for example, a username the customer uses to log in to the website, or any other customer identifier.

Database 116 may further store item event data 380. Item event data 380 identifies item-related information. For example, item event data 380 may include historical item prices 382, which identifies previous prices for each of a plurality of items. In some examples, anomaly detection computing device 102 determines historical item prices 382 based on item prices identified in in-store purchase data 302 and/or online purchase data 304. For example, anomaly detection computing device 102 may identify, for an order identified by in in-store purchase data 302 or online purchase data 304, a price of an item ordered, a date of when the item was purchased, and an identifier of where the item was purchased (e.g., store 109 or on a website hosted by web server 104), and store the price, date, and identifier as historical item prices 382. Historical item prices 382 may also identify a time period of when each price was in effect. For example, anomaly detection computing device 102 may detect when the price of an item changes for a same store or website, determine the date of the change, and store the price and date as historical item prices 382.

Item event data may also identify historical item costs 390, which identifies the cost of each of the plurality of items. Historical item costs 390 may also identify a time period associated with the cost of each item. Item event data 380 may further include inventory amounts 384, which may identify current and previous inventory levels, and associated time periods, for each of the plurality of items. The costs and inventory amounts may be provided to anomaly detection computing device 102 by an associate of a retailer via, for example, I/O device 203. In some examples, each store (e.g., store 109) transmits cost and inventory amounts periodically to anomaly detection computing device 102.

Further, item event data 380 may also include order create events 386, which identify a number of times each of the plurality of items was ordered over a period of time. For example, order create events 386 may identify how many times an item was ordered in each one month period over the last five years. In some examples, order create events 386 may identify how many times an item was ordered in each week over the last year. Order create events 386 may identify the number of orders of each item for each store, and for each website. These time periods are merely exemplary and may preconfigured, for example. In some examples, anomaly detection computing device 102 determines order create events 386 based on in-store purchase data 302 and/or online purchase data 304, and stores order create events in database 116.

Item event data 380 may further include order cancel events 388, which identify a number of times an order for each of the plurality of items was cancelled over a period of time. For example, order cancel events 388 may identify how many times an order including the item was cancelled in each one month period over the last five years. In some examples, order cancel events 388 may identify how many times an order including the item was cancelled in each week over the last year. Order cancel events 388 may identify the number of times orders of each item were cancelled for each store, and for each website. These time periods are merely exemplary and may preconfigured, for example. In some examples, anomaly detection computing device 102 determines order cancel events 388 based on order cancellations identified in in-store purchase data 302 and/or online purchase data 304, and stores order cancel events 388 in database 116.

For each order identified by in-store purchase data 302 and/or online purchase data 304, anomaly detection computing device 102 may determine whether an anomaly, such as an item price anomaly, may exist. To detect anomalies, anomaly detection computing device 102 may execute a rule-based model, such as one identified by rule-based model data 390 stored in database 116, and a machine learning based model, such as one identified by machine learning model data 392.

For example, anomaly detection computing device 102 may obtain rule-based model data 390 from database 116, and parse rule-based model data 390 to extract the rule-based model. Similarly, anomaly detection computing device 102 may obtain machine learning model data 392 from database 116, and parse machine learning model data 392 to extract the machine learning model. In some examples, anomaly detection computing device 102 trains the machine learning model with one or more of online transaction data 360, store transaction data 340, and item event data 380. For example, anomaly detection computing device 102 may train the machine learning model with item unit price, a store price, and a discounts. In some examples, the machine learning model is also trained with aggregated data, such as data aggregated for the last 30, 60, 90, 180, or 365 days. The aggregated data may be determined based on one or more statistical functions such as mean (e.g., the mean of an item price over the last 30 days), standard deviation, median absolute deviation, IQR, adjusted box plot scores, minimum data (e.g., the minimum item price over the last 30 days), and maximum data (e.g., the maximum item price over the last 30 days), for example.

Anomaly detection computing device 102 may then execute the rule-based model and/or the machine learning model as in-store purchase data 302 and/or online purchase data 304 is received to detect anomalies. If, for example, anomaly detection computing device 102 detects an anomaly for an item in an order identified in in-store purchase data 302 received from store 109, anomaly detection computing device 102 may generate, and transmit to store 109, store anomaly detection 303 identifying a suspected anomaly with the item. For example, store anomaly detection 303 may identify the item and, in some examples, the price of the item that led to the anomaly detection (e.g., the price of the item in the order that caused the anomaly detection). In some examples, store anomaly detection 303 may include the item price, the current item inventory level (or current item delivery amounts), or current item cost. In response, store 109 may generate an indication of the anomaly to an associate of a retailer (e.g., a communication, light an LED, etc.). In some examples, store 109 (via workstation 106) may prevent the stores purchase system (e.g. a store's POS system) from allowing further sales of the item until the price of the item is adjusted or verified.

Similarly, if anomaly detection computing device 102 detects an anomaly for an item in an order identified online purchase data 304 received from web server 104, anomaly detection computing device 102 may generate, and transmit to web server 104, online anomaly detection 312 identifying a suspected anomaly with the item. For example, online anomaly detection 312 may identify the item and, in some examples, the price of the item that led to the anomaly detection (e.g., the price of the item in the order that caused the anomaly detection). In some examples, online anomaly detection 312 may include the item price, the current item inventory level (or current item delivery amounts), or current item cost. In response, web server 104 may generate an indication of the anomaly to an associate of a retailer (e.g., a communication, light an LED, etc.), and, in some examples, prevent further sales of the item on the website until the price of the item is adjusted or verified.

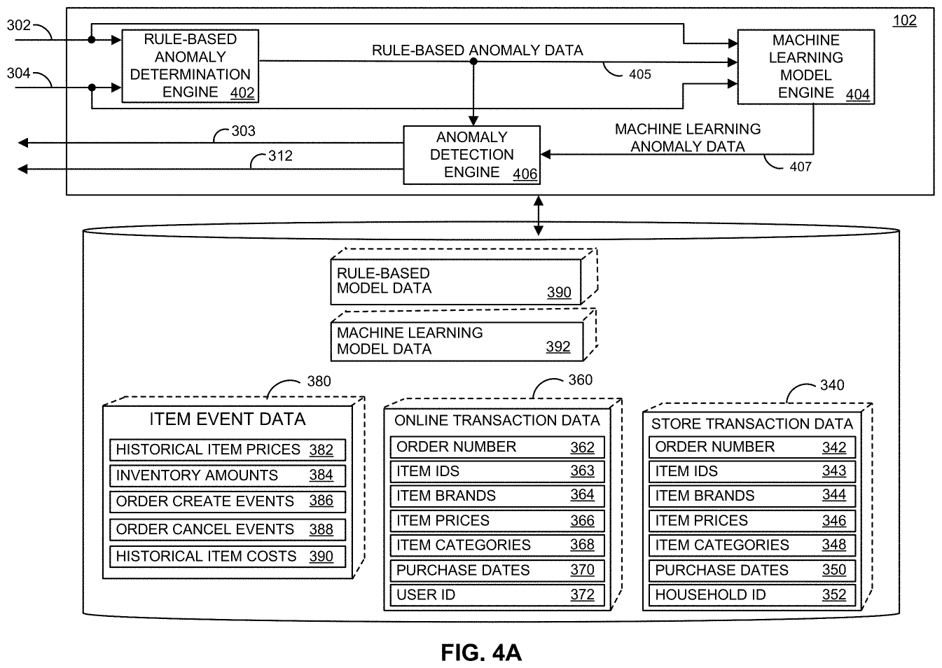

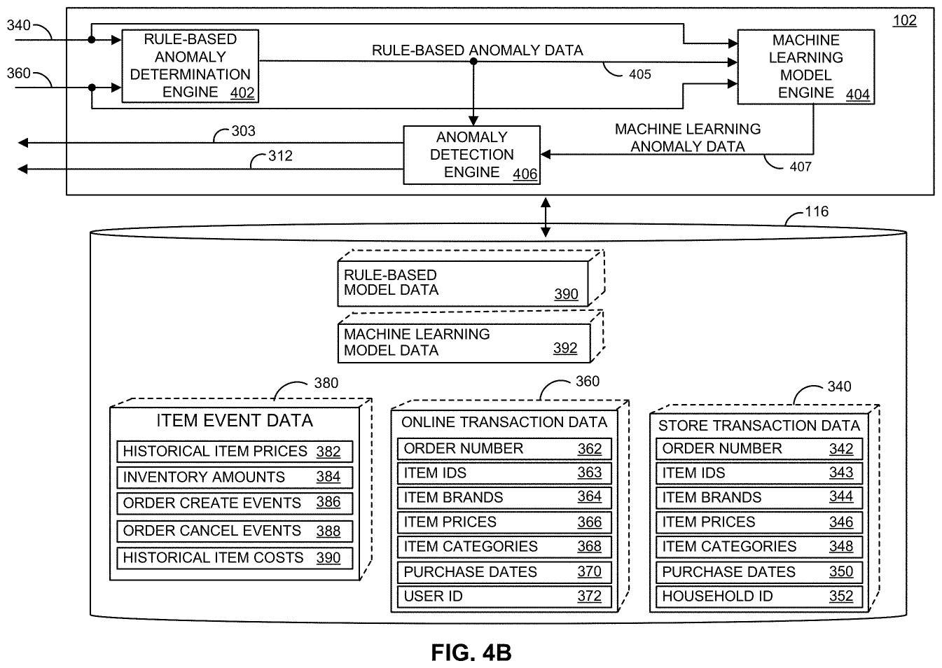

FIG. 4A illustrates further exemplary portions of the anomaly detection computing device 102 of FIG. 1. As indicated in FIG. 4A, anomaly detection computing device 102 includes rule-based anomaly determination engine 402, machine learning model engine 404, and anomaly detection engine 406. In some examples, one or more of rule-based anomaly determination engine 402, machine learning model engine 404, and anomaly detection engine 406 are implemented in hardware. In some examples, one or more of rule-based anomaly determination engine 402, machine learning model engine 404, and anomaly detection engine 406 are implemented as an executable program maintained in a tangible, non-transitory memory, such as instruction memory 207 of FIG. 2, which may be executed by one or processors, such as processor 201 of FIG. 2.

In this example, rule-based anomaly determination engine 402 is configured to execute a rule-based anomaly model, such as one identified by rule-based model data 390. Rule-based anomaly determination engine 402 may receive in-store purchase data 302 from store 109 and parse store transaction data 340 to identify data, such as items and corresponding prices. Rule-based anomaly determination engine 402 may then generate, based on execution of one or more rules that operate on the extracted data, rule-based anomaly data 405 identifying an output value.

Similarly, rule-based anomaly determination engine 402 may receive online purchase data 304 from web server 104, parse online purchase data 304 to identify data the rules operate on, and generate, based on execution of one or more rules, rule-based anomaly data 405 identifying the output value. The output value may be based on a number of rules of the rule-based model that may have been violated. Rule-based anomaly determination engine 402 provides rule-based anomaly data 405 to machine learning model engine 404, and to anomaly detection engine 406.

Machine learning model engine 404 can receive in-store purchase data 302 from store 109 and, in this example, rule-based anomaly data 405 from rule-based anomaly determination engine 402. Machine learning model engine 404 may parse in-store purchase data 302 to identify and extract items and prices of the items (e.g., per purchase order). In some examples, machine learning model engine 404 obtains item event data 380 from data base 116 for each of the items. Machine learning model engine 404 may execute a trained machine learning model that operates on the items, corresponding prices, and the rule-based anomaly data 405. In some examples, the trained machine learning model, when executed, also operates on item event data 380 for each of the items. Based on executing the trained machine learning model, machine learning model engine 404 generates machine learning anomaly data 407 identifying an output value. The output value may indicate a likelihood (e.g., probability) that an anomaly exists for an item.

Similarly, machine learning model engine 404 can receive online purchase data 304 from web server 104. Machine learning model engine 404 may parse online purchase data 304 to identify and extract items and prices of the items (e.g., per purchase order). In some examples, machine learning model engine 404 obtains item event data 380 from data base 116 for each of the items. Machine learning model engine 404 may execute a trained machine learning model that operates on the items, corresponding prices, and rule-based anomaly data 405. In some examples, the trained machine learning model, when executed, also operates on item event data 380 for each of the items. Based on executing the trained machine learning model, machine learning model engine 404 generates machine learning anomaly data 407 identifying the output value.

Anomaly detection engine 406 receives machine learning anomaly data 407 from machine learning model engine 404, and also receives rule-based anomaly data 405 from rule-based anomaly determination engine 402. Based on rule-based anomaly data 405 and machine learning anomaly data 407, anomaly detection engine 406 may determine whether an anomaly is suspected for an item. For example, anomaly detection engine 406 may execute one or more statically processes (e.g., algorithms) that operate on rule-based anomaly data 405 and machine learning anomaly data 407 to detect anomalies.

In some examples, anomaly detection engine 406 applies a coefficient (e.g., a weighting) to the output values identified by each of rule-based anomaly data 405 and machine learning anomaly data 407, and combines the results to generate a final value (e.g., final score). If the final value is beyond (e.g., above) a threshold, anomaly detection engine 406 determines an anomaly for the corresponding item exists.

Assuming the item is for one received via in-store purchase data 302, anomaly detection engine 406 generates store anomaly detection 303 identifying the anomaly (e.g., as discussed further above), and transmits store anomaly detection 303 to store 109. If the item is for one received via online purchase data 304, anomaly detection engine 406 generates online anomaly detection 312 identifying the anomaly (e.g., as discussed further above), and transmits online anomaly detection 312 to web server 104. As such, in some examples, anomaly detection computing device 102 may detect anomalies in real-time (e.g., as purchase orders are received via in-store purchase data 302 and online purchase data 304).

FIG. 4B is similar to FIG. 4A. In this example, however, anomaly detection computing device 102 determines anomalies based on store transaction data 340 and/or online transaction data 360 stored in database 116. For example, anomaly detection computing device 102 may obtain store transaction data 340 and/or online transaction data 360 from database 116 periodically, such as nightly, weekly, monthly, or any other period of time, to determine any anomalies.

Specifically, rule-based anomaly determination engine 402 obtains store transaction data 340 and/or online transaction data 360 from database 116, parses store transaction data 340 and/or online transaction data 360 to identify data such as items and corresponding prices, and generates, based on execution of one or more rules, rule-based anomaly data 405. Machine learning model engine 404 obtains store transaction data 340 and/or online transaction data 360, as well as rule-based anomaly data 405, and executes the trained machine learning model to generate machine learning anomaly data 407.

As described above, anomaly detection engine 406 receives machine learning anomaly data 407 from machine learning model engine 404, and rule-based anomaly data 405 from rule-based anomaly determination engine 402. Based on rule-based anomaly data 405 and machine learning anomaly data 407, anomaly detection engine 406 may generate store anomaly detection 303 and/or online anomaly detection 312 identifying one or more anomalies. Store 109 may receive store anomaly detection 303, and respond as described herein. Similarly, web server 104 may receive online anomaly detection 312, and response as described herein. As such,

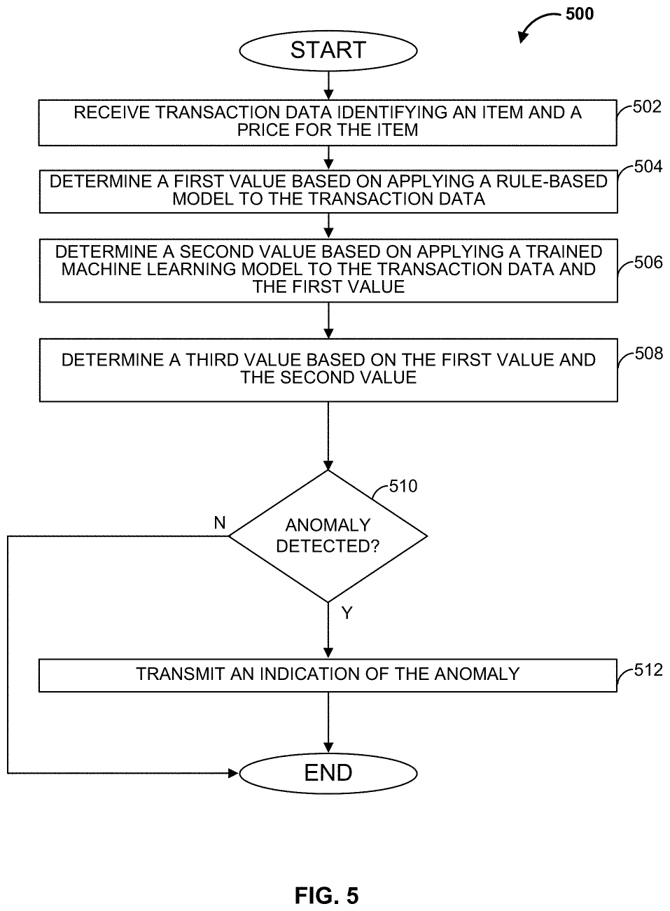

FIG. 5 is a flowchart of an example method 500 that can be carried out by the anomaly detection system 100 of FIG. 1. Beginning at step 502, a computing device, such as anomaly detection computing device 102, receives transaction data identifying an item and a price for the item. For example, anomaly detection computing device 102 may receive in-store purchase data 302 form store 109, or online purchase data 304 from web server 104. At step 504, a first value is determined based on applying a rule-based model to the transaction data. For example, anomaly detection computing device 102 may obtain from database 116 rule-based model data 390, parse rule-based model data 390 to extract the rule-based model, and execute the rule-based model to operate on the transaction data to generate rule-based anomaly data 405 identifying the first value.

Proceeding to step 506, a second value is determined based on applying a trained machine learning model to the transaction data and the first value. For example, anomaly detection computing device 102 may obtain from database 116 machine learning model data 392, parse machine learning model data 392 to extract the trained machine learning model, and execute the trained machine learning model to operate on the transaction data and the first value to generate machine learning anomaly data 407 identifying the second value.

At step 508, a third value is determined based on the first value and the second value. For example, anomaly detection computing device 102 may determine the third value based on a mathematical relationship between the first value and the second value. For example, anomaly detection computing device 102 may weight each of the first value and the second value, and determine the third value based on the weighted first and second values.

The method then proceeds to step 510, where a determination is made as to whether, based on the third value, an anomaly is detected. For example, if the third value is above a threshold, an anomaly for the item is detected. If an anomaly is not detected, the method ends. Otherwise, if an anomaly is detected, the method proceeds to step 512, where an indication of the anomaly is transmitted. For example, anomaly detection computing device 102 may transmit store anomaly detection 303 to store 109, or may transmit online anomaly detection 312 to web server 104. The method then ends.

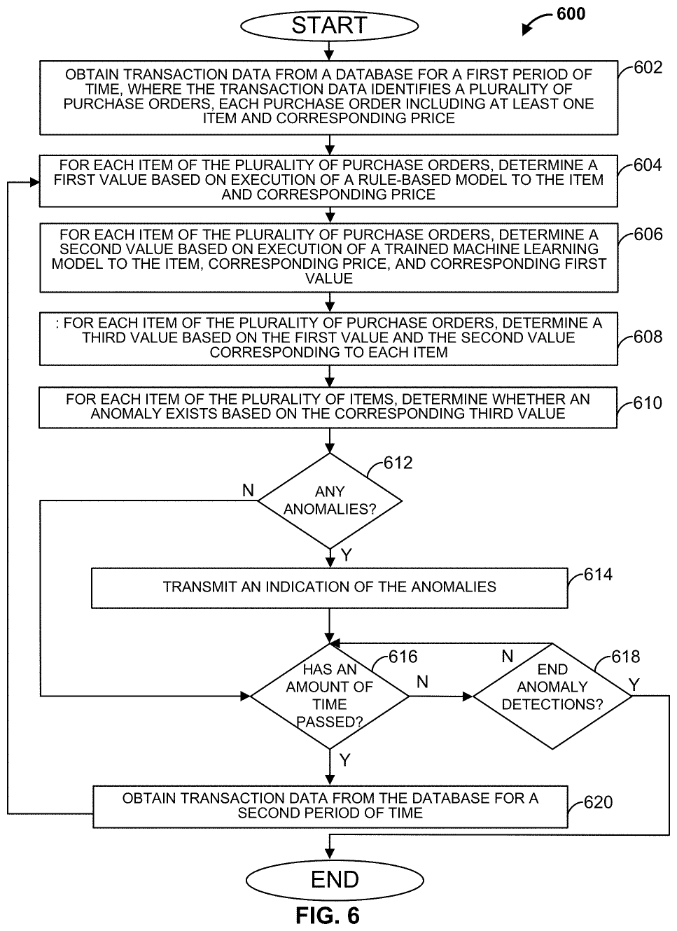

FIG. 6 is a flowchart of another example method 600 that can be carried out by the anomaly detection system 100 of FIG. 1. Beginning at step 602, a computing device, such as anomaly detection computing device 102, obtains transaction data (e.g., online transaction data 360 or store transaction data 340) from a database (e.g., database 116) for a first period of time. The transaction data identifies a plurality of purchase orders, each purchase order including at least one item and corresponding price for each item. The first period of time may be, for example, a week, a month, or a quarter. The transaction data identifies purchase orders during the first period of time.

At step 604, for each item of the plurality of orders, a first value is determined based on execution of a rule-based model (e.g., as identified by rule-based model data 390) to the item and corresponding price. At step 606, for each item of the plurality of orders, a second value is determined based on execution of a trained machine learning model (e.g., as identified by machine learning model 392) to the item, the corresponding price, and the corresponding first value for the item. At step 608, for each item of the plurality of orders, a third value is determined based on the first value and the second value corresponding to each item. For example, anomaly detection computing device 102 may weight each of the first value and the second value, and determine the third value based on the weighted first and second values.

At step 610, for each item of the plurality of orders, a determination is made as to whether an anomaly exists for each item based on the third value. For example, if the third value for an item is above a threshold, an anomaly for the item is detected. Otherwise, if the third value for the item is not above the threshold, an anomaly for the item is not detected. At step 612, a determination is made as to whether any anomalies were detected at step 612. If there were any anomalies detected, the method proceeds to step 614. At step 614, an indication of each anomaly is transmitted. For example, anomaly detection computing device 102 may transmit store anomaly detection 303 to store 109 for anomalies detected for items sold at store 109, or may transmit online anomaly detection 312 to web server 104 for anomalies detected for items sold on a website hosted by web server 104. The method then proceeds to step 616. If, back at step 612, there were no anomalies detected, the method proceeds directly to step 616 (e.g., bypassing step 614).

At step 616, a determination is made as to whether an amount of time has passed. In some examples, the amount of time is the same as the first period of time. For example, the amount of time may be a day, a week, a month, a quarter, or a year. In some examples, the amount of time is less than the first period of time. In yet other examples, the amount of time is greater than the first period of time. If the amount of time has not passed, the method proceeds to step 618, where a determination is made as to whether anomaly detections should end. For example, an associate of a retailer may provide input to anomaly detection computing device 102 via I/O device 203 that anomaly detections should end. In other examples, anomaly detections automatically end after a preconfigured amount of time. If the anomaly detections are to end, the method ends. Otherwise, if the anomaly detections are to continue, the method proceeds back to step 616.

At step 616, if the amount of time has passed, the method proceeds to step 620. At step 620, transaction data is obtained from the database for a second period of time. The second period of time may be determined based on the first period of time and the amount of time passed. For example, the first period of time may be a month, and the amount of time passed may be two weeks. The second period of time may be also for a length of a month, but starting from two weeks after the first period of time began. As such, anomaly detection computing device 102 may obtain transaction data on a rolling window basis. These periods of time are merely exemplary, and other periods of time may be employed. The method then proceeds back to step 604, where anomaly detection will begin for the newly obtained transaction data covering the second period of time.

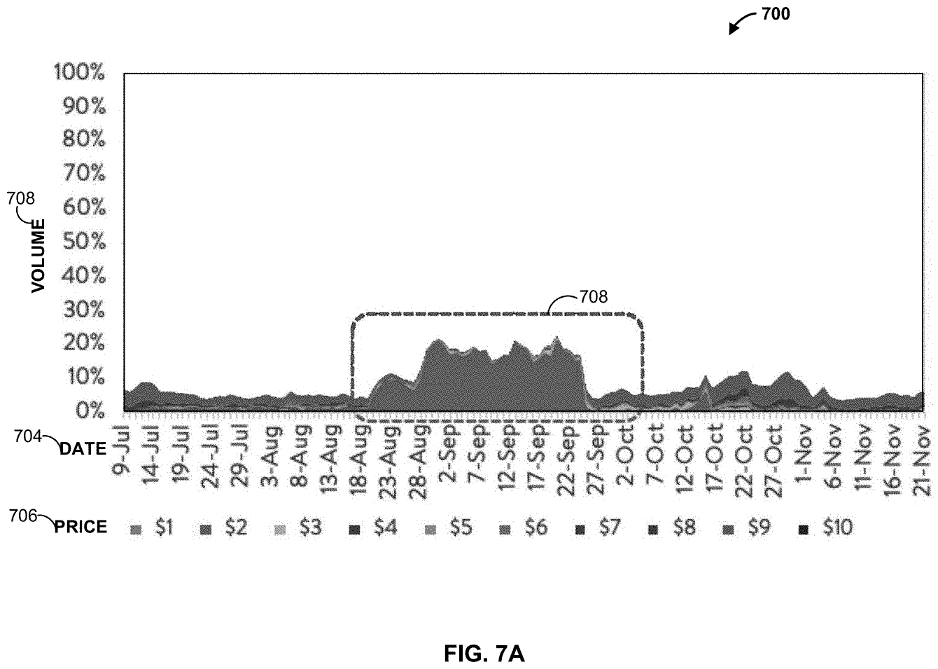

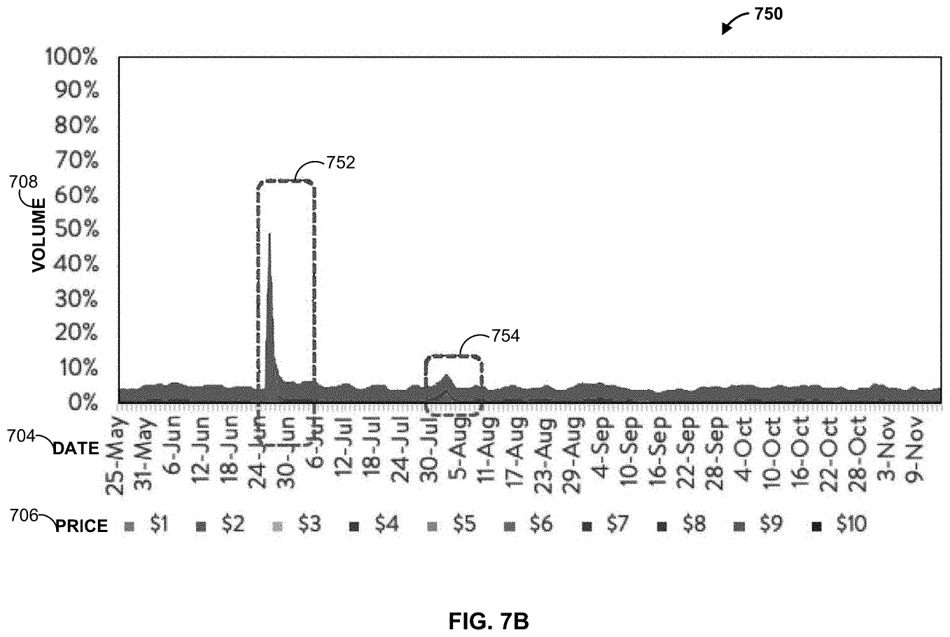

FIG. 7A illustrates a graph 700 that plots item volume 708 (e.g., item volume sales) on the vertical axis, with dates 704 and prices 706 along the horizontal axis. For each date 704, the chart indicates item volumes 708 at one or more prices 706. For example, for each date range (e.g., between two dates 704), the item may have been sold at a store, such as store 109, at one or more prices 706. Box 708 identifies a range of dates (e.g., from August 18 to September 27) for which item volumes 708 for the item surged. In some examples, one or more of these item volume surges in box 108 may cause a violation of a rule, such as one executed by a rule-based model. For example, if the rule may specify that if item sales for one month exceed a threshold amount (e.g., an average amount based on historical sales), the rule may be violated in box 708. Similarly, a trained machine learning model as described herein may generate output data indicating a higher likelihood of an anomaly during the time period covered by box 708 than during other time periods of graph 700. Based on the output values of the rule-based model and the trained machine learning model, anomaly detection computing device 102 may generate and transmit data (e.g., store anomaly detection 303 or online anomaly detection 312) indicating an anomaly for the item sold during the time period in box 708.

FIG. 7B illustrates a graph 750 that also plots item volume 708 (e.g., item volume sales) on the vertical axis, with dates 704 and prices 706 along the horizontal axis. In this example, box 752 illustrates a major surge in item volume 708 during the corresponding period. Box 754 also illustrates a surge in item volume 708, but to a lesser extent than box 752. In some examples, based on execution of a rule-based model and a trained machine learning model, anomaly detection computing device 102 may determine an anomaly for the item sold during the time periods and prices corresponding to box 752 (e.g., a pricing error led to the surge), but not for box 754. In some examples, based on execution of a rule-based model and a trained machine learning model, anomaly detection computing device 102 may determine an anomaly for the item sold during the time period and prices corresponding to box 752, and may also determine an anomaly for the item sold during the time period and prices corresponding to box 754.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive transaction data identifying an item and a price of an item;
determine a first value based on applying a rule-based model to the item and the price of the item;
determine a second value based on applying a machine learning model to the item, the price of the item, and the first value;
determine a third value based on the first value and the second value;
determine, based on the third value, whether the price of the item is an anomaly; and
transmit an indication that the price of the item is an anomaly.

2. The system of claim 1, wherein determining the first value based on applying the rule-based model to the item and the price of the item comprises:
obtaining historical price data identifying historical prices for the item;
applying a first rule to the price of the item and the historical price data for the item; and
determining the first value based on application of the first rule.

3. The system of claim 2, wherein applying the first rule comprises comparing the price of the item to an average of the historical prices for the item.

4. The system of claim 1, wherein the computing device is configured to train the machine learning model with first historical transaction data identifying a first plurality of purchase orders, wherein each purchase order includes at least one item and a corresponding price.

5. The system of claim 4, wherein the first plurality of purchase orders were made over a first predetermined period of time.

6. The system of claim 5, wherein the computing device is configured to:
detect that a second period of time has passed;
when the second period of time has passed, obtain second historical transaction data identifying a second plurality of purchase orders made over a second predetermined period of time; and
retrain the machine learning model with the second historical transaction data.

7. The system of claim 1, wherein determining the third value based on the first value and the second value comprises:
determining a first weighted value based on applying a first weight to the first value;
determining a second weight value based on applying a second weight to the second value; and
determining the third value based on the first weighted value and the second weighted value.

8. The system of claim 1, wherein determining the first value based on applying the rule-based model to the item and the price of the item comprises:
obtaining a first delivery amount of the item during a first period of time;
obtaining second delivery amounts of the item during a plurality of second periods of time;
comparing the first delivery amount to the second delivery amounts; and
determining the first value based on the comparison.

9. The system of claim 1, wherein determining, based on the third value, whether the price of the item is an anomaly comprises:
determining whether the third value is beyond a threshold; and
determining the price of the item is an anomaly when the third value is beyond the threshold.

10. The system of claim 1 comprising a web server, wherein the computing device transmits the indication that the price of the item is an anomaly, and wherein, in response to the indication, the web server is configured to disable purchases of the item on a website.

11. A method comprising:
receiving transaction data identifying an item and a price of an item;
determining a first value based on applying a rule-based model to the item and the price of the item;
determining a second value based on applying a machine learning model to the item, the price of the item, and the first value;
determining a third value based on the first value and the second value;
determining, based on the third value, whether the price of the item is an anomaly; and
transmitting an indication that the price of the item is an anomaly.

12. The method of claim 11 wherein determining the first value based on applying the rule-based model to the item and the price of the item comprises:
obtaining historical price data identifying historical prices for the item;
applying a first rule to the price of the item and the historical price data for the item; and
determining the first value based on application of the first rule.

13. The method of claim 12 wherein applying the first rule comprises comparing the price of the item to an average of the historical prices for the item.

14. The method of claim 11 further comprising training the machine learning model with first historical transaction data identifying a first plurality of purchase orders, wherein each purchase order includes at least one item and a corresponding price.

15. The method of claim 14 wherein the first plurality of purchase orders were made over a first predetermined period of time.

16. The method of claim 15 further comprising:
detecting that a second period of time has passed;
when the second period of time has passed, obtaining second historical transaction data identifying a second plurality of purchase orders made over a second predetermined period of time; and
retraining the machine learning model with the second historical transaction data.

17. The method of claim 11, wherein determining the third value based on the first value and the second value comprises:
determining a first weighted value based on applying a first weight to the first value;
determining a second weight value based on applying a second weight to the second value; and
determining the third value based on the first weighted value and the second weighted value.

18. The method of claim 11, wherein determining the first value based on applying the rule-based model to the item and the price of the item comprises:
obtaining a first delivery amount of the item during a first period of time;
obtaining second delivery amounts of the item during a plurality of second periods of time;
comparing the first delivery amount to the second delivery amounts; and
determining the first value based on the comparison.

19. The method of claim 11, wherein determining, based on the third value, whether the price of the item is an anomaly comprises:
determining whether the third value is beyond a threshold; and
determining the price of the item is an anomaly when the third value is beyond the threshold.

20. A non-transitory computer readable medium having instructions stored thereon, wherein the instructions, when executed by at least one processor, cause a device to perform operations comprising:
receiving a request to update a value;
determining a machine learning model to apply to the value based on the received request;
determining whether the request is an anomaly based on application of the machine learning model to the value;
allowing the update to the value if the request is determined not to be an anomaly; and
denying the update to the value if the request is determined to be an anomaly.
